(19) United States
(12) Patent Application Publication
(10) Pub. No.: US 2025/0196959 A1
(43) Pub. Date: Jun. 19, 2025

(54) SPLASH GUARD FOR PARTIALLY COVERING A WET REGION SURROUNDING A ROTATING COMPONENT

(71) Applicant: Technische Universität Graz, Graz (AT)

(72) Inventor: Hans Peter Schnöll, Graz (AT)

(21) Appl. No.: 18/977,559

(22) Filed: Dec. 11, 2024

(30) Foreign Application Priority Data
Dec. 14, 2023 (EP) 23216685.0

(51) Int. Cl. B62J 15/00

(52) U.S. Cl. CPC B62J 15/00

(57) ABSTRACT

A splash guard partially covers a wet region (2) surrounding a rotatable component (1), and a bicycle (19) may be equipped with such a splash guard. The splash guard comprises a protective profile (3), which forms two flow channels (4, 5) extending in the longitudinal direction of the profile and being closed with respect to the wet region (2). Between the flow channels (4, 5) an inflow opening (6) is provided, in the region of which a flow divider (7) is arranged for dividing a liquid from the wet region (2) into the two flow channels (4, 5).

The invention relates to a splash guard for partially covering a wet region surrounding a rotatable component, in particular a wheel. The invention also relates to a bicycle with a splash guard.

A splash guard used in connection with wheels rotatable components, which splash guard in this context is generally referred to as a mudguard or fender, is known, for example, from DE10235674A1, EP3854666A1, or DE102010055321A1. Such a splash guard typically serves to protect the cyclist from splash water on a wet road surface, which detaches tangentially from the running surface of the rotating wheel in the direction of a wet region formed between the splash guard and the wheel due to centrifugal force.

However, such a splash guard according to the state of the art has the disadvantage that the splash water is often insufficiently drained off or drips directly from the splash guard onto the bicycle, the rider or back onto the running surface, so that the splash water subsequently hits sensitive drive components or ultimately also the cyclist. This is particularly problematic in weather conditions where dirt is also picked up from the wet road surface along with the water, resulting in the risk of damage to the bike due to the abrasive effect of the dirt in the water.

There is therefore a need for a splash guard of the type described at the beginning, which offers improved protection for both the cyclist and the bicycle against dirt and moisture on the road surface with a compact design and simple manufacturing conditions.

The invention solves the task set by a protective profile which forms two flow channels extending in the longitudinal direction of the profile and being closed with respect to the wet region, between which flow channels an inflow opening is provided, in the region of which a flow divider is arranged for dividing a liquid from the wet region into the two flow channels.

As a result of these features, any spray or dirty water that detaches tangentially from the rotatable component in the direction of the wet region hits the flow divider and is thus divided into two partial flows, with each partial flow flowing into a flow channel via the inflow opening. Preferably, the flow divider is arranged in the center of the profile, as the spray and dirty water usually detaches from the center of the surface of the rotatable component. In particular, the flow divider runs in a center plane with respect to which the protective profile is symmetrical. The inflow opening can preferably form two inflow areas, each of which is assigned to a flow channel. In particular, the inflow opening can extend in the longitudinal direction of the profile, with the inflow areas forming corresponding inflow gaps. The flow divider is designed in particular as a flow guide ridge facing the wet region and extending in the longitudinal direction of the profile between the flow channels. The flow conditions set by the flow divider according to the invention create the prerequisite that the respective partial flow into the flow channel transverse to the longitudinal direction of the profile along the inner wall of the channel towards a collecting region viewed from the cross-section of the flow channel is favored, whereby, depending on the geometric design of the flow channels, a reduction of the kinetic energy of the spray water is subsequently promoted. This reduces the risk of the spray water flowing out of the flow channel back into the wet region. The water in the flow channel is thus easily discharged in the longitudinal direction of the profile along the flow channel.

In principle, a splash guard according to the invention can be used to partially cover any component that can rotate about an axis of rotation. A preferred application is in connection with bicycles, whereby the wheels form the rotatable components. Accordingly, the invention also relates to a bicycle with a splash guard according to the invention. In principle, the protective profile can run essentially in a straight line in the longitudinal direction of the profile, but can also run in a curved shape, for example. In the case of curved protective profiles, the longitudinal direction of the profile essentially corresponds to the circumferential direction of the curve.

Design conditions are favorable if the protective profile, with respect to its profile width, has two free profile flanks opposite each other, which extend to the flow divider arranged in the middle of the profile, forming the flow channels and the inflow opening leading to them. For the purposes of the invention, a free profile flank is understood to be a profile flank with a free end which extends to the flow divider arranged in the center of the profile in such a way that spray or dirty water can easily flow from the wet region into the flow channels via the inflow opening. The protective profile can, for example, have a modular structure or be designed as a single piece. The respective profile flanks can be bent in towards the flow divider arranged in the center of the profile to form the flow channels. In principle, it is possible for the respective flow channel to taper in cross-section from the inflow opening to a collecting region opposite the inflow opening. In this context, advantageous manufacturing conditions result if a respective profile flank is bent in to form the collecting region. A further advantage is that the resulting cross-sectional contour of the profile flank is also accompanied by a certain stiffening of the protective profile, which in turn leads to increased stability of the splash guard.

In order to further reduce the risk of water flowing back from a flow divider into the wet region, it is proposed that the free end of the respective profile flank in the region of the inflow opening is bent away from the flow divider towards the respective flow channel. With a corresponding design, this reduces the flow cross-section of the inflow opening or the corresponding inflow regions from the wet region towards the flow channel. Consequently, the inflow of a liquid from the wet region via the inflow opening into the flow channel is favored, whereas an outflow of the liquid from the flow channel back into the wet region is further impeded.

Basically, with a splash guard, especially if it is used in connection with wheels respectively bicycle wheels as rotatable components, care must be taken to ensure that in the mounted state there is a sufficiently large wet region in cross-section or a sufficient distance between the protective profile and the rotatable component so that the protective profile does not create any additional resistance or undesirable noise development. Against this background, advantageous inflow and collection conditions with regard to the liquid on the one hand, as well as reliable operating conditions on the other hand, result if the free end of the respective profile flank has a flank section with a concave cross-section in relation to the flow channel formed by the profile flank, which flank section is adjoined in the direction of the profile center by a flank section with a convex cross-section in relation to this flow channel. This results in a cross-sectional contour of the flank section extending towards the center of the profile that is bulged out from the wet region towards the flow channel in a structurally favorable manner. This offers the advantage that the flow of liquid from the wet region via the inflow opening into the respective flow channels is not impeded by the profile flanks, while conversely the resulting, essentially S-shaped cross-sectional contour of the respective flank section favors the accumulation of liquid in the collecting region and largely reduces backflow into the wet region.

Simple integration of any cables that are connected to a lighting device, for example, can be achieved by the flow divider having a hollow cross-section with a cable lead-through running in the longitudinal direction of the profile.

To ensure that the liquid collected by the splash guard can reliably return from the splash guard to the road surface, thereby reducing the risk of secondary staining of the cyclist or the bicycle, it is recommended that the respective flow channel leads to a water-discharging device in the longitudinal direction of the profile at at least one profile end section. In the simplest case, the water-discharging device can be designed similar to a nozzle. However, the water-discharging device can also be designed as a diffuser, manifold or distributor. For example, the flow channels can lead to a common discharge pipe. However, a discharge pipe can also be assigned to each flow channel, with each of the discharge pipes discharging the water laterally past the corresponding tire or transversely to the longitudinal direction of the profile. In principle, it is also possible for the flow channels of a profile end section to be flow-connected to the opposite profile end section in the longitudinal direction of the profile via a flow line, which can be designed as a mounting strut, for example, and lead to the flow channel region there. By that the liquid is only discharged at one end section of the profile.

Depending on the profile end sections on which a water-discharging device is provided, different designs may be appropriate. Water-discharging devices that are arranged on the front wheel side at the front end of the profile in relation to the direction of travel can preferably be designed in such a way that the liquid flowing off via the flow channels is specifically diverted onto the tire in a region where the centrifugal force and gravity converge in their direction, so that the liquid no longer detaches from the tread again, but is carried along by the tire in the direction of the road. In the case of water-discharging devices that are arranged on the rear wheel side at the front end of the profile relative to the direction of travel, a design can be provided so that the liquid is guided past the side of the tire. In contrast, water-discharging devices that are arranged both at the front and rear of the wheel at the rear end of the profile relative to the direction of travel can be designed in such a way that the liquid is directed onto the road surface. Preferably, the liquid is directed onto the road surface, forming a kind of liquid curtain transversely, in particular perpendicular to the road surface, so that the liquid curtain forms a barrier for the spray or dirty water that separates tangentially from the tire surface in the region between the tire contact point and the rear profile end, which thus passes underneath the water-discharging device. As a result, the cyclist behind is reliably protected from splash and dirty water from the cyclist immediately in front, particularly during group training rides. In order to reduce the risk of damage to the water-discharging device in the event of a collision, it may also be provided that at least the water-discharging device is made of a applicable elastic material.

Although a protective profile that runs curved in the longitudinal direction of the profile can in principle span an arc angle of less than 180°, it is recommended for an even better protective effect if the protective profile that runs curved in the longitudinal direction of the profile spans an arc angle of more than 180°, preferably between 180° and 320°.

The drawing shows an example of the subject matter of the invention. It shows

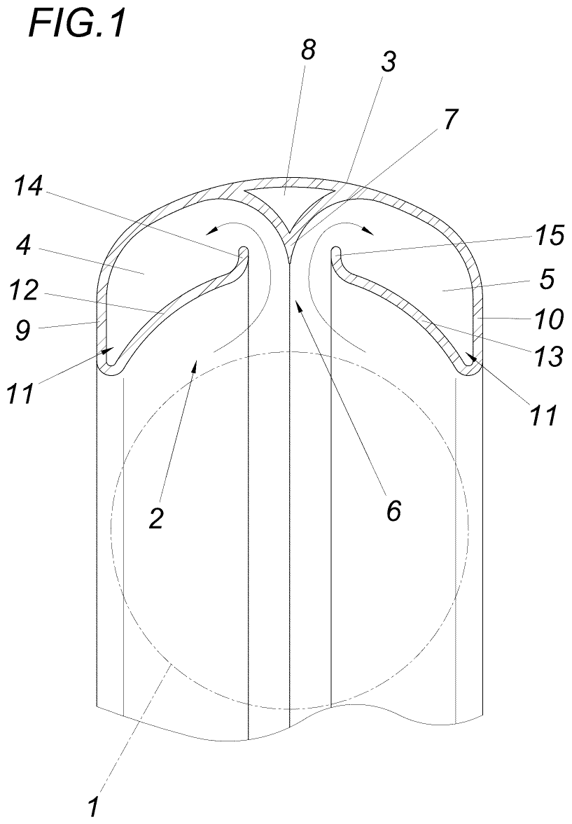

FIG. 1 a schematic sectional view of a protective profile and a bicycle tire as a rotatable component,

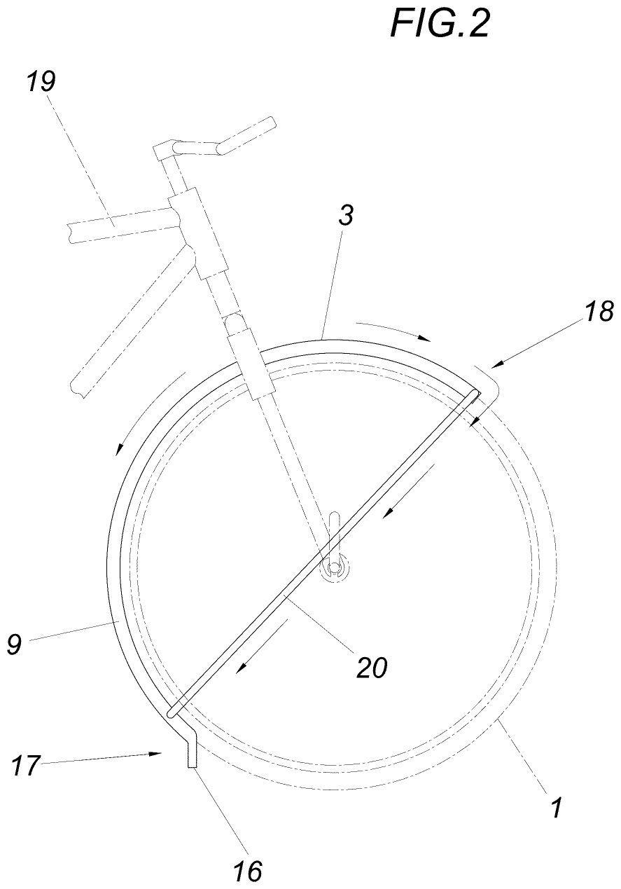

FIG. 2 a schematic oblique view of a cut-off profile end section on a larger scale,

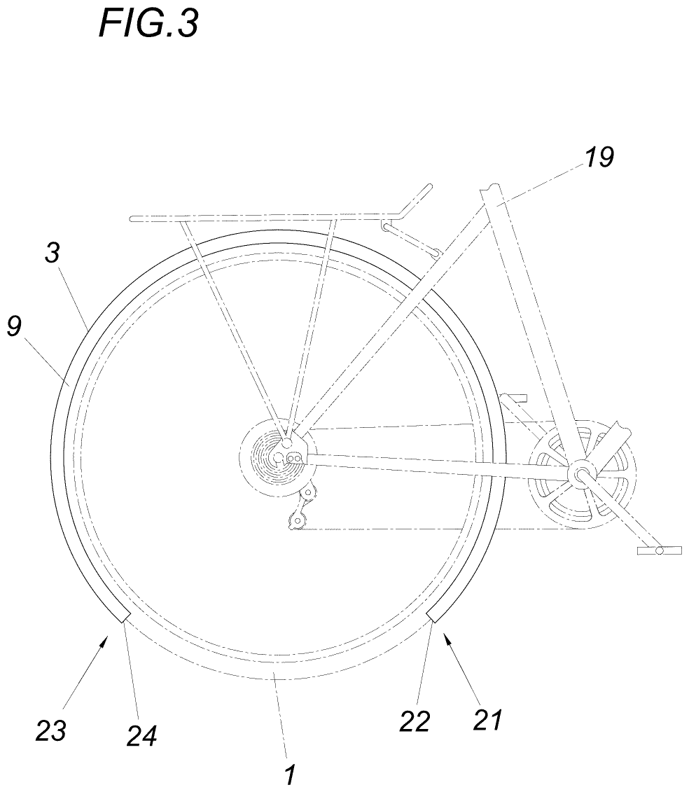

FIG. 3 a schematic side view of a front wheel with a splash guard according to the invention in a first embodiment on a smaller scale, and

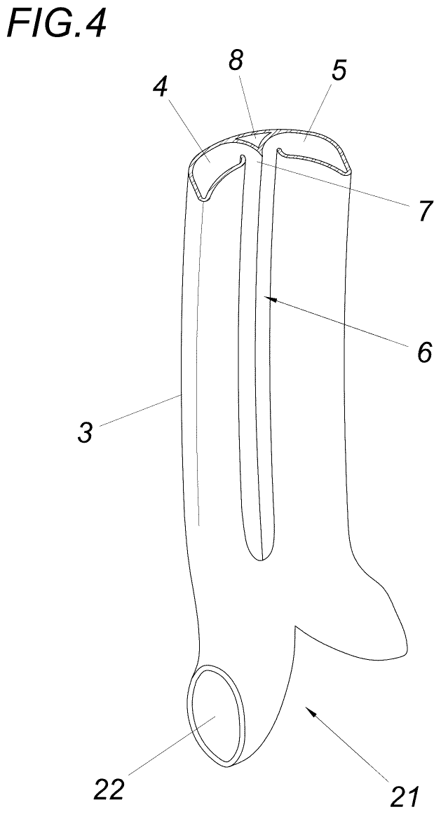

FIG. 4 a schematic side view of a rear wheel with a splash guard according to the invention in a further embodiment.

A splash guard according to the invention for partially covering a wet region 2 surrounding a rotatable component 1 comprises a protective profile 3 which forms two flow channels 4, 5 extending in the longitudinal direction of the profile and closed with respect to the wet region 2. In the present embodiment example, the rotatable component 1 is a bicycle tire, whereby this is only indicated schematically in FIG. 1 by a dotted circle representing the cross-section of the bicycle tire for reasons of clarity.

An inflow opening 6 is provided between the flow channels 4, 5, which has a flow divider 7 designed as a flow guide ridge for dividing a liquid from the wet region 2 into the two flow channels 4, 5. The flow divider 7 also has a hollow cross-section forming a cable lead-through 8 running in the longitudinal direction of the profile. The flow divider 7 runs in a central plane with respect to which the protective profile 3 is symmetrical.

The flow channels 4, 5 and the inflow opening 6 are formed in that the preferably one-piece protective profile 3, with respect to its profile width, has two opposing free profile flanks 9, 10, which extend to the flow divider 7 arranged in the center of the profile. The respective flow channel 4, 5 tapers in cross-section from the inflow opening 6 to a collecting region 11 opposite it. As shown in FIGS. 1 and 2, the respective profile flank 9, 10 can be curved to form the collecting region 11. In addition, the free end of the respective profile flank 9, 10 has a flank section 12, 13 which is concave in cross-section with respect to the flow channel 4, 5 formed by the profile flank 9, 10 and which is adjoined in the direction of the profile center by a flank section 14, 15 which is convex in cross-section with respect to this flow channel 4, 5. The convex flank section 14, 15 is therefore bent away from the flow divider 7 towards the respective flow channel 4, 5 in the region of the inflow opening 6.

On the one hand, the design of the splash guard according to the invention enables liquid to flow into the flow channels 4, 5 via the inflow opening 6 in a reliable manner and with as little splashing as possible, as well as draining off the liquid in the longitudinal direction of the profile, and on the other hand largely prevents undesired backflow into the wet region 2.

FIG. 2 shows a splash guard for the front wheel of a bicycle 19. As indicated schematically, the flow channels 4, 5 of a profile end section 18 can be flow-connected to the opposite profile end section 17 in the longitudinal direction of the profile via a flow line 20 designed as a mounting strut and open into the flow channel area there and ultimately into a water-discharging device 16.

FIG. 3 shows a splash guard for the rear wheel of the bicycle 19, with the protective profile 3 running in a curved shape in the longitudinal direction of the profile and spanning an arc angle of approx. 270°. A water-discharging device 22 can be provided at the front profile end section 21 and a water-discharging device 24 at the rear profile end section 23.

FIG. 4 illustrates a possible design of a water-discharging device 22, into which the respective flow channel 4, 5 opens in the longitudinal direction of the profile at the profile end section 21. As can also be seen from FIG. 4, the inflow opening 6 extends in the longitudinal direction of the profile.

1. A splash guard for partially covering a wet region surrounding a rotatable component, said splash guard comprising:
a member having a protective profile that forms two flow channels that extend in a longitudinal direction of the protective profile, and that are closed with respect to the wet region, and
the member having, between the flow channels, an inflow opening, and a flow divider arranged in a region of the inflow opening, said flow divider dividing a liquid from the wet region so the liquid proceeds into the two flow channels.

2. The splash guard according to claim 1, wherein the protective profile has two free profile flanks opposite each other with respect to a profile width of the protective profile, the profile flanks extending to the flow divider, which is arranged in a middle of the profile so as to form the flow channels and the inflow opening leading thereto.

3. The splash guard according to claim 1, wherein the flow divider is a flow guide ridge facing the wet region and extending in the longitudinal direction of the profile between the flow channels.

4. The splash guard according to claim 1, wherein the flow channels each taper in cross-section from the inflow opening to a collecting region opposite the inflow opening.

5. The splash guard according to claim 4, wherein each of the profile flanks is curved to form the respective collecting region.

6. The splash guard according to claim 2, wherein each of the profile flanks has a respective free end in the region of the inflow opening that is bent away from the flow divider and towards the respective flow channel.

7. The splash guard according to claim 6, wherein each of the profile flanks has a respective free end of the respective profile flank that has a first flank section that is concave in cross-section with respect to the flow channel formed by the profile flank, and the first flank section is adjoined in a direction of a center of the profile by a second flank section that is convex in cross-section with respect to the associated flow channel.

8. The splash guard according to claim 1, wherein the flow divider has a hollow cross-section forming a cable lead-through passage.

9. The splash guard according to claim 1, wherein the flow channels lead in the longitudinal direction of the profile to least one profile end section and to a water-discharging device.

10. The splash guard according to claim 1, wherein the flow divider extends in a central plane with respect to which the protective profile is symmetrical.

11. The splash guard according to claim 1, wherein the protective profile extends in a curved manner in the longitudinal direction of the profile and spans an arc angle of more than 180°.

12. A bicycle comprising:
a frame supported a wheel; and
a splash guard according to claim 1 supported so as to partially surround said wheel.

13. The splash guard according to claim 2, wherein the flow divider is a flow guide ridge facing the wet region and extending in the longitudinal direction of the profile between the flow channels.

14. The splash guard according to claim 13, wherein the flow channels each taper in cross-section from the inflow opening to a collecting region opposite the inflow opening.

15. The splash guard according to claim 14, wherein each of the profile flanks is curved to form the respective collecting region.

16. The splash guard according to claim 15, wherein each of the profile flanks has a respective free end in the region of the inflow opening that is bent away from the flow divider and towards the respective flow channel.

17. The splash guard according to claim 16, wherein the free ends of each of the profile flanks has a respective first flank section that is concave in cross-section with respect to the flow channel formed by the profile flank, and the first flank section is adjoined in a direction of a center of the profile by a second flank section that is convex in cross-section with respect to the associated flow channel.

18. The splash guard according to claim 17, wherein the flow divider has a hollow cross-section forming a cable lead-through passage.

19. The splash guard according to claim 18, wherein the flow channels lead in the longitudinal direction of the profile to at least one profile end section and to a water-discharging device.

20. The splash guard according to claim 19, wherein the flow divider extends in a central plane with respect to which the protective profile is symmetrical.
